(19) United States
(12) Patent Application Publication
(10) Pub. No.: US 2026/0199722 A1
(43) Pub. Date: Jul. 16, 2026

(54) Fire Protection Assembly with a Shielded Automatic Fire Protection Sprinkler

(71) Applicant: Minimax Viking Patent Management GmbH, Bad Oldesloe (DE)

(72) Inventors: Martin H. WORKMAN, Delton, MI (US); James E. GOLINVEAUX, Ada, MI (US); Shawn G. ORR, Grand Rapids, MI (US); Connor G. CERVONE, Byron Center, MI (US)

(21) Appl. No.: 19/559,026

(22) Filed: Mar. 6, 2026

Related U.S. Application Data
(63) Continuation of application No. PCT/US2025/054520, filed on Nov. 7, 2025.
(60) Provisional application No. 63/718,308, filed on Nov. 8, 2024.
(60) Provisional application No. 63/735,973, filed on Dec. 19, 2024.

(51) Int. Cl. A62C 31/24; A62C 3/00; A62C 37/12

(52) U.S. Cl. CPC A62C 31/24; A62C 3/002; A62C 37/12

(57) ABSTRACT

A fire protection assembly that includes a pipe wall disposed along a central pipe axis defining a supply volume and a fitting wall transverse to the pipe wall and defining a fitting volume between the supply volume and a terminal end of the fitting wall. An inlet end of the fitting wall can be secured to the pipe wall and an outlet end of the fitting wall can be opposite and spaced from the inlet end along a fitting axis. The fitting volume can accommodate a fire protection device. The fitting wall can be an impervious wall. The fire protection assembly can include a passageway having a passage inlet orifice in fluid communication with the supply volume and a passage outlet orifice for discharging the firefighting fluid. Preferably, at least the passage outlet orifice is disposed within the fitting volume.

### PRIORITY CLAIM & INCORPORATION BY REFERENCE

This application is a continuation of International Application No. PCT/US2025/054520, filed Nov. 7, 2025, which claims the benefit of U.S. Provisional Patent Application No. 63/718,308 , filed on Nov. 8, 2024, and U.S. Provisional Patent Application No. 63/735,973 , filed Dec. 19, 2024, each of which application is incorporated by reference in its entirety.

### TECHNICAL FIELD

The present invention relates generally to fire extinguishing systems and, in particular, to fire extinguishing systems having fire protection assemblies with a shielded fire protection device.

### BACKGROUND ART

Fire protection assemblies, which can include an automatic sprinkler, are well known and have long been used in fire extinguishing systems to protect storage occupancies, including rack storage systems. When the fire protection assembly includes an automatic sprinkler assembly, the automatic sprinkler assembly is typically identified as the sprinkler, and includes a sprinkler body having an inlet for connecting to a pressurized supply of water or other firefighting fluid, an outlet opening, and a deflector to distribute the firefighting fluid to address a fire and/or wet the surrounding area of the fire. The outlet opening of the sprinkler is normally closed in an unactuated state of the sprinkler by a closure seal held in place by a thermally responsive trigger. In response to a sufficient level of heat from a fire or other thermal event, the thermally responsive trigger operates or actuates to release the closure seal thereby permitting the firefighting fluid to discharge from the outlet opening to impact the deflector for distribution. The fire protection assembly can be configured for installation in pendent orientation mounted within a rack storage configuration (“in-rack system”). In such installations, firefighting fluid is discharged to impact the deflector in a vertical direction from above a shelf of the in-rack system onto the items stored on the shelf.

The sprinkler in such fire protection assemblies can be exposed and thus susceptible to damage due to activity near the fire protection assemblies. For example, when a fire protection assembly is installed in an in-rack system, the loading and unloading of items into/from the rack storage configuration can cause damage to the sprinkler if the items and/or the forklift contact the sprinkler. To mitigate the problem, the frame assemblies of the rack storage configuration can include beams that serve as a barrier between the shelf storage area and the fire protection assembly. However, in some cases, the sprinkler of the fire protection assembly can extend beyond the beam, which can expose the sprinkler to potential damage. Even in cases where the fire protection assembly is protected by a beam of the frame assembly, if the forklift arms are at an angle when loading or unloading the items, the ends of the arms can extend under the beam and hit the fire protection assembly.

To protect an automatic fire protection sprinkler of a known fire protection assembly from potential damage, a protective member for the automatic fire protection sprinkler, such as a guard and/or cage that surround the sprinkler, is provided. Illustrative examples of known protective members are shown and described in U.S. Pat. Nos. 11,260,415 and 11,548,027. These known protective members provide protection for the sprinkler and allow the sprinkler to be positioned in a rack storage configuration such that heat from a fire can flow to the automatic fire protection sprinkler both radially and axially relative to a center axis of the automatic fire protection sprinkler to actuate a thermally responsive trigger assembly of the automatic fire protection sprinkler. Due to this conceived operational requirement of the thermally responsive trigger of the automatic fire protection sprinkler, the protection members are located in an exposed position within the rack storage configuration, which allows for the protection member and the associated sprinkler to be physically damaged.

### DISCLOSURE OF INVENTION

Preferred embodiments of the present invention include a fire protection assembly with a shielded fire protection device. Preferably, the fire protection device includes a thermally responsive trigger that is located within a shield that constrains heat from a fire to flow to the fire protection device axially relative to a center axis of the device. These preferred embodiments can be utilized in rack storage configurations and provide actuation of the thermally responsive trigger to address a fire in the rack storage configuration, as the inventors have demonstrated that a fire protection device positioned within a rack storage configuration with a conventional protection member that allows for heat from a fire to flow both radially and axially relative to a center axis of the fire protection device is unnecessary for actuation of the thermally responsive trigger to address a fire in a rack storage configuration. Rather, only the axial flow of heat from a fire is necessary to actuate a thermally responsive trigger assembly of a fire protection device located in a rack storage configuration.

The systems, assemblies, and methods disclosed herein include providing a fitting (e.g., a straight fitting or an angled fitting) in fluid communication with a fluid supply pipe and locating a fire protection device (e.g., an automatic fire protection sprinkler) within a protection chamber of the fitting. In some embodiments, a fire protection assembly includes a pipe wall disposed along a central pipe axis defining a supply volume and a fitting wall transverse to the pipe wall and defining a fitting volume between the supply volume and a terminal end of the fitting wall. In some embodiments, the fitting wall includes a pipe coupling portion and a device coupling portion. The pipe coupling portion can be disposed transverse to the pipe wall and the device coupling portion can be disposed adjacent to the pipe coupling portion. The pipe and device coupling portions can be disposed such that the respective central axes of the pipe and device coupling portions form an angle relative to each other. Preferably, the device coupling portion defines the fitting volume. Thus, whether straight or angled, at a least a portion of the fitting wall can act as a shield for the components of the fire protection device disposed within the fitting volume. An inlet end of the fitting wall can be secured to the pipe wall and an outlet end of the fitting wall can be opposite and spaced from the inlet end. In preferred embodiments, the fitting wall is an impervious wall. Preferably, the fire protection assembly includes an automatic fire protection sprinkler with a passageway (e.g., a passageway corresponding to the fitting volume) having a passage inlet orifice in fluid communication with the supply volume either directly or indirectly (e.g., via a volume defined by the pipe coupling portion) and a passage outlet orifice for discharging the firefighting fluid. Preferably, the passage outlet orifice is disposed within the fitting volume. In some embodiments, the passageway, including the passage inlet orifice and the passage outlet orifice, is an integral part of the fitting wall.

However, in other embodiments, a separate component can comprise the passageway. For example, in some embodiments, the fire protection assembly can include a fire protection device that preferably includes a device housing. Preferably, a first portion of the device housing can define the passageway and a second portion of the device housing can support components of the fire protection device such as, for example, a fluid deflection member, an outlet orifice sealing assembly, and/or a thermally responsive trigger. Preferably, the second portion of the device housing can define a device chamber that contains at least the fluid deflection member. Preferably, at least a portion of the fitting volume can accommodate at least a portion of the fire protection device. In some embodiments, the fitting volume can accommodate the entire fire protection device such that the fire protection device is shielded when the fire protection device is disposed within the protection chamber. In some embodiments, the first portion of the device housing can have an external thread that circumscribes the device housing and engages a corresponding internal thread disposed in the fitting wall. In some embodiments, the second portion of the device housing can have an external thread that circumscribes the device housing and engages a corresponding internal thread disposed in the fitting wall.

In some embodiments, the pipe wall can be a wall of a pipe header and/or the fitting wall can be a wall of a fitting connector (or pipe fitting). However, the pipe wall and/or the fitting wall can be a part of other types of piping configurations and/or piping interconnects. In some embodiments, the passageway of the fire protection device defines a nominal K-factor of the fire protection device. As is known in the art, and as defined herein, the nominal K-factor of a fire protection device (e.g. an automatic fire protection sprinkler) is defined as K=Q/P^{1/2}, where Q represents the flow rate (gallons/min (gpm) of firefighting fluid from an outlet of an internal passage through a body of the sprinkler and P represents the pressure (pounds per square inch (psi)) of firefighting fluid fed into an inlet end of the internal passageway through the body of the sprinkler. Accordingly, the designed performance of a sprinkler is a function of the supply of a minimum fluid pressure or flow. Thus, any restriction to the fluid flow supply to a sprinkler can negatively impact the performance of a sprinkler. In some embodiments, the nominal K-factor can be 2.8[gpm/(psi)^{1/2}] or greater, preferably a nominal K-factor in a range of 11.2 to 33.6 [gpm/(psi)^{1/2}], and more preferably a nominal K-factor that is any one of 11.2, 14.0, 16.8, 19.6, 22.4, 25.2, 28.0, 30.8, or 33.6[gpm/(psi)^{1/2}].

In some embodiments, the fire protection assembly includes a preferred fitting connector for connecting a fire protection device to a pipe header in a network of pipes of the in-rack system. In some embodiments, the fitting connector can include a fitting wall that is arranged around a central axis Y-Y to form a generally tubular member (e.g., unitary tubular member) having a fitting inlet end that is fluidly connected to a supply volume and a fitting outlet end to receive a fire protection device. Preferably, the fitting connector includes an internal fitting passageway extending along a central longitudinal axis from the fitting inlet end to the fitting outlet end. In some embodiments, an internal fitting surface of the internal fitting passageway includes a mechanical coupling portion (e.g., a threaded portion) for coupling to a fire protection device. Depending on the type of fire protection device, one or more mechanical coupling portions can be disposed proximate to the fitting inlet end, proximate to the fitting outlet end and/or at any point between the fitting inlet end and the fitting outlet end. Preferably, the fitting wall can define a fitting volume between the supply volume and a terminal end of the fitting connector.

Preferably, the fitting volume is defined at least in part by an impervious wall such that the fitting volume shields and/or protects at least a portion of the fire protection assembly from accidental damage and/or impingement of firefighting fluid distribution from other fire protection devices. The fitting volume can also be referred to herein as a “protection chamber” of the fire protection device. For example, the fire protection assembly can include a passageway, which can have a passage inlet orifice and a passage outlet orifice, that is protected by the protection chamber. In some embodiments, the fire protection assembly can include a fire protection device that is disposed within the protection chamber and shielded by the impervious wall. Preferably, the passageway can be disposed within the fire protection device. In some embodiments, the fire protection device includes a device housing that defines the passageway, and the device housing can be disposed within the protection chamber. In some embodiments, an outlet orifice, a fluid deflection member, and/or a thermally responsive trigger of the fire protection device can be disposed within the device housing and/or within the protection chamber. In some embodiments, the entire fire protection device is disposed within the protection chamber when in the unactuated state and a portion of the fire protection device is external to the protection chamber when in the actuated state. In some embodiments, the fire protection device, in both the unactuated state and the actuated state, is disposed within the protection chamber. For clarity, the following description discusses an embodiment in which the fire protection device is a sprinkler. However, other types of fire protection devices can be any thermally actuated structure configured to distribute a firefighting fluid when in the presence of sufficient heat.

Additional embodiments provide for a preferred fire protection assembly configured for installation in an in-rack fire protection system, a pendent fire protection system, a horizontal fire protection system, an upright fire protection system, and/or another type of fire protection system in which the fire protection device can be exposed to accidental damage and/or impingement of firefighting fluid from another fire protection device.

### BRIEF DESCRIPTION OF DRAWINGS

The accompanying drawings, which are incorporated herein and constitute part of this specification, illustrate exemplary embodiments of the invention, and together with the general description given above and the detailed description given below, serve to explain the features of the invention. It should be understood that the preferred embodiments are some examples of the invention as provided by the appended claims.

FIG. 1 illustrates an in-rack fire protection system that is consistent with embodiments of the present disclosure.

FIG. 1A illustrates a perspective view of a fire protection assembly that is consistent with the present disclosure.

FIG. 1B illustrates a front cross-section view of the fire protection assembly of FIG. 1A.

FIG. 1C illustrates a front cross-section view of the fire protection assembly of FIG. 1A but with the sprinkler removed.

FIG. 2A illustrates a perspective view of another fire protection assembly that is consistent with the present disclosure.

FIG. 2B illustrates a side cross-section view of the fire protection assembly of FIG. 2A.

FIG. 3A illustrates a perspective view of a sprinkler that can be used in the fire protection assemblies of FIGS. 1A and 2A.

FIGS. 3B and 3C are cross-sectional views of the sprinkler of FIG. 3A.

### MODE(S) FOR CARRYING OUT THE INVENTION

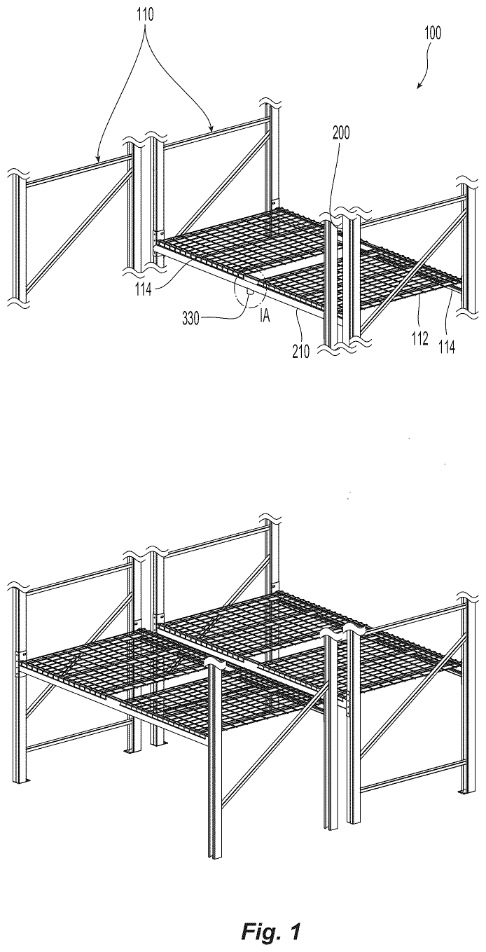

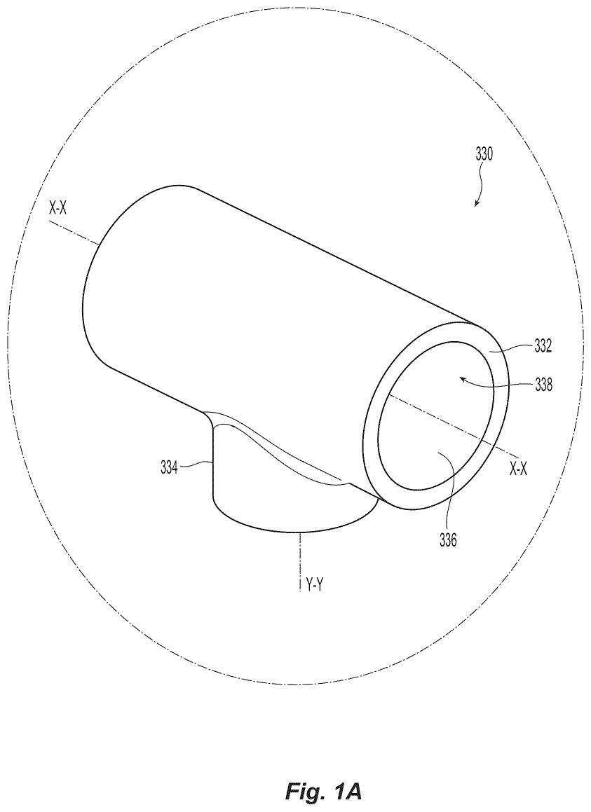

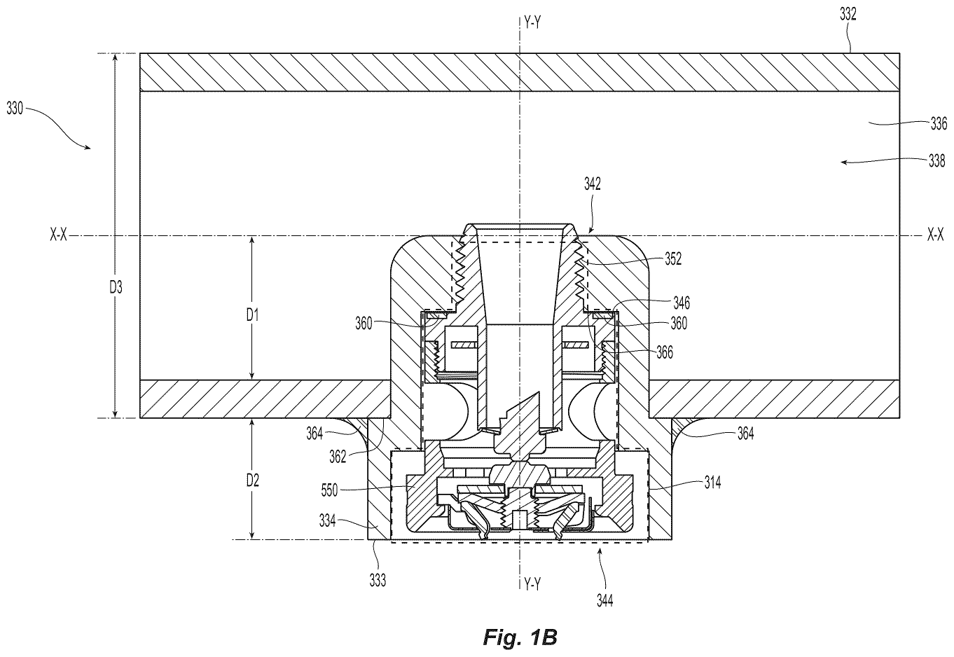

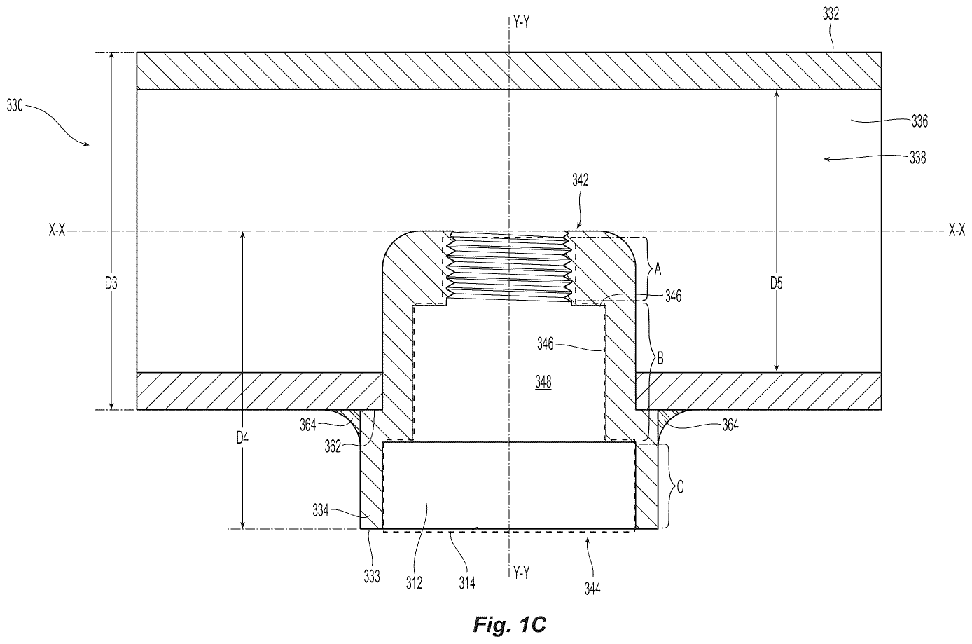

FIG. 1 illustrates an in-rack fire protection system 100 (also referred to herein as “in-rack system”). In FIG. 1, some shelves and beams of a frame assembly 110 of a storage rack of the in-rack system 100 are removed to show the in-rack system 100 more clearly. Preferably, the in-rack system 100 includes one or more frame assemblies 110 with each frame assembly 110 including one or more shelves 112. For example, the shelves 112 in each frame assembly 110 can be disposed in a multi-level shelf configuration that includes two or more shelves 112 that are stacked on top of each other. In some embodiments, the frame assemblies 110 can be arranged in a side-by-side configuration. For example, in the embodiment of FIG. 1, the two frame assemblies 110 are arranged side-by-side in a double-rack configuration. However, in other embodiments, the frame assemblies can be a single-rack configuration or have more than two frame assemblies arranged side-by-side. In some embodiments, frame assemblies 110 can include beams 114. Preferably, in addition to the protection chamber discussed below, the beams 114 of the frame assembly 110 can serve to protect fire protection assemblies 330 by acting as a barrier that minimizes accidental contact between shelf items and/or a forklift and the fire protection assemblies 330. In some embodiments, the fire protection assemblies 330 may rely exclusively on the built-in protection in the fire protection assemblies, as discussed below, to protect the fire protection device.

The in-rack system 100 can include a riser pipe 200 that can be connected to a fluid supply source (e.g., water main, firefighting fluid storage tank, or some other source). The firefighting fluid can be water or another type of firefighting fluid. The in-rack system 100 can also include one or more branch lines 210 that branch off from the riser pipe 200 in a lateral direction. Preferably, each branch line 210 is fluidly connected to the riser pipe 200 and, in some embodiments, the branch line 210 can be welded to the riser pipe 200. However, other connection methods can also be used such as, for example, a threaded connection, a grooved coupling, an interference fit, a snap fit, a soldered connection, a glued connection, and/or another type of connection method.

The in-rack system 100 includes one or more fire protection assemblies 330 for discharging firefighting fluid onto the shelves 112 to protect the items stored on the shelves 112. In some embodiments, the branch line(s) 210 can be routed above the one or more shelves 112 such that the firefighting fluid is discharged on top of the items stored on the respective shelves 112. Each branch line 210 can supply one or more fire protection assemblies 330 protecting one or more shelves disposed on one or more levels of one or more frame assemblies 110. In some embodiments, rows of fire protection assemblies 330 can be disposed at predetermined intervals in the vertical direction to protect one or more shelves 112 disposed below the respective row. Preferably, the predetermined interval can be up to 40 feet (or more). For example, for a frame assembly 110 that is 50 feet high, two rows of fire protection assemblies 330 can be disposed every 20 feet to protect the shelf or shelves 112 below each row. To protect the top shelves 112, a row of fire protection assemblies 330 can be disposed above the frame assembly 110 and/or the fire protection assemblies 330 can be disposed in the ceiling above the frame assembly 110. Of course, depending on the configuration of the frame assembly and/or the items being stored, the predetermined distance can be more or less than 20 feet.

In some embodiments, each branch line 210 supplies one or more fire protection assemblies 330 protecting one or more shelves disposed on a same level of one or more frame assemblies 110. For example, as shown in FIG. 1, each branch line 210 supplies a respective fire protection assembly 330, and each fire protection assembly 330 protects two or more shelves 112 on the same level (e.g., one shelf on each frame assembly 110). The two shelves 112 can respectively be part of one or more shelves 112 arranged vertically in the respective frame assemblies 110. In some embodiments, as shown in FIG. 1, each branch line 210 can be disposed between the frame assemblies 110 such that each fire protection assembly 330 protects one or more shelves 112 in each frame assembly 110. In some embodiments, one or more branch lines 210 can extend to supply fire protection assemblies mounted in adjacent frame assemblies (not shown). In some embodiments, the fire protection assembly (or assemblies) 330 and the corresponding branch line 210 can be disposed above the items to be protected along a centerline of the one or more shelves 112 of the frame assembly 110, instead of between the frame assemblies 110. Preferably, each fire protection assembly 330 and the corresponding branch line 210 is disposed above the shelf or shelves 112 to be protected such that axial heat flow from the protected shelves 112 (specifically, from a fire located on or proximate the protected shelves 112) is received by the fire protection device of the fire protection assembly 330.

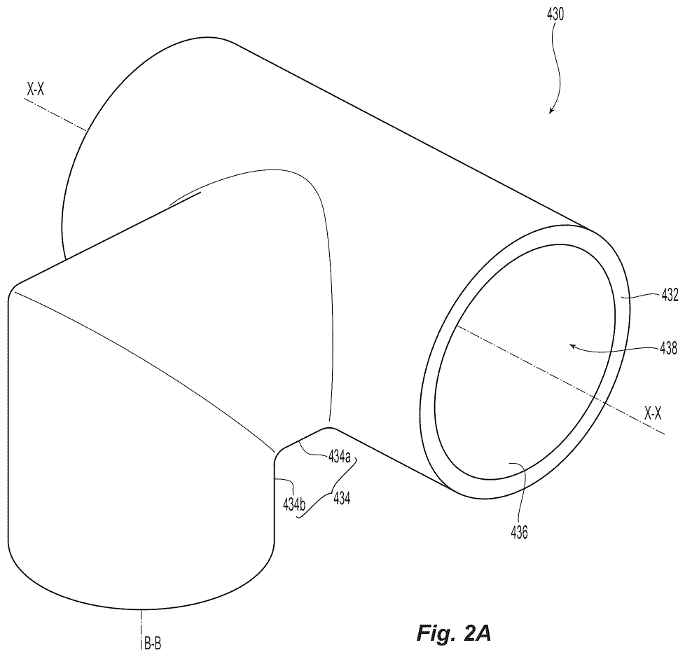

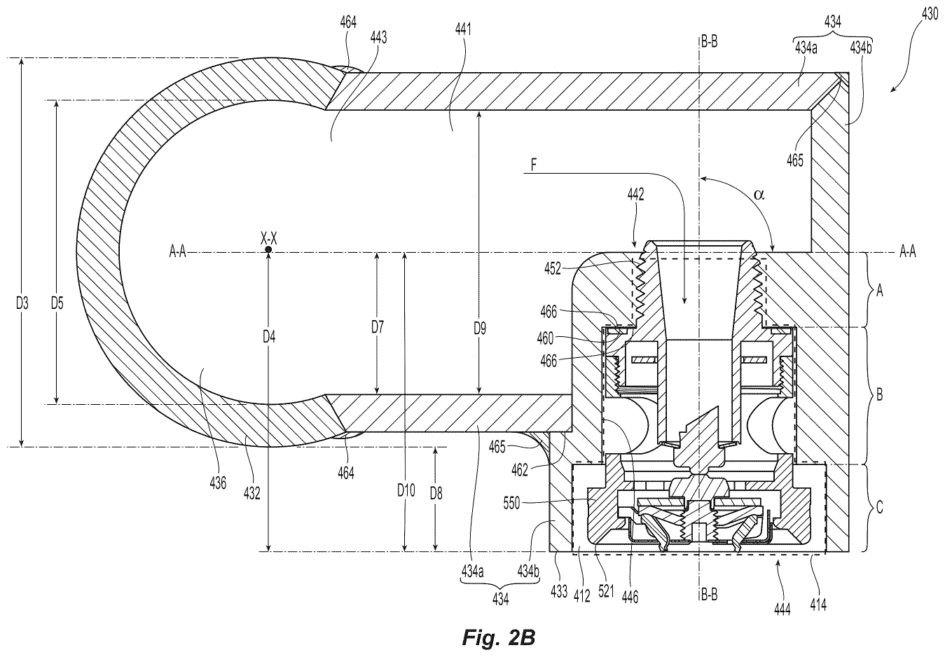

In some embodiments, the fire protection assembly 330 can include the branch line 210. That is, the branch line 210 can be an integral component of the one or more fire protection assemblies 330. For example, the branch line 210 can form the main body of the fire protection assembly 330, and the fire protection assembly 330 can include a fitting connector (e.g., straight fitting wall 334 in FIG. 1A and angled fitting wall 434 in FIG. 2A) that can be transverse to and fluidly connected to the branch line 210. “Fitting connector” or “fitting wall,” as used herein means, a fitting that is configured to directly and fixedly to a pipe or line. Preferably, the fitting is directly and fixedly coupled to the pipe or line via a weld. However, other connection technologies can be employed, such as, solder, glue, mechanical fit (e.g., a press fit), or integration of the materials of the fitting connector or wall and the pipe, to provide a permanent connection between the fitting connector or wall. Preferably, the fire protection assembly 330 can include a fire protection device (not shown in FIG. 1) that can be fluidly connected to the fluid supply via the fitting connector (e.g., straight fitting wall 334 in FIG. 1A and angled fitting wall 434 in FIG. 2A). In some embodiments, a plurality of spaced apart fitting connectors, each connected to a fire protection device, can be connected to a branch line 210.

In some embodiments, at least a portion of the fire protection assembly can be a single monolithic structure that includes a branch line (e.g., branch line 210) with a permanent connection with one or more branch connectors, which are disposed transversely to the branch line (e.g., similar to fitting connectors). That is, the branch line and the one or more branch connectors are not separate components. In some embodiments, each branch connector can include an integrated passageway having a passageway inlet orifice and a passageway outlet orifice for distributing firefighting fluid. Thus, in these embodiments, the branch connector is configured to include features (e.g., a passageway with an inlet orifice and an outlet orifice) similar to those in a housing of a fire protection device. In other embodiments, the passageway is not integrated into the branch connector. For example, the passageway can be part of a separate fire protection device that is coupled to the respective branch connector.

In the above embodiments, the monolithic fire protection assembly (with or without the integrated passageway) includes the branch line. In some embodiments, however, the monolithic fire protection assembly can be a separate component from the branch line (e.g., branch line 210). In such embodiments, the fire protection assembly can be fluidly coupled to a branch line 210 (e.g., via welding, a threaded coupling, a tongue and groove coupling, mechanical fit, a soldered coupling, a glued coupling, or some other type of coupling). For example, in some embodiments, the monolithic fire protection assembly can be a “T-shaped” structure. The T-shaped fire protection assembly can include a main passageway and a branch passageway that is traverse to the main passageway. The main passageway can be fluidly coupled to a branch line and/or riser pipe to receive firefighting fluid. In some embodiments, the branch connector can include an integrated passageway having a passageway inlet orifice and a passageway outlet orifice for distributing the firefighting fluid. Thus, in these embodiments, the branch connector of the T-shaped fire protection assembly is configured to include features (e.g., a passageway with an inlet orifice and an outlet orifice) similar to those in a housing of a fire protection device. In other embodiments, the passageway is not integrated into the branch connector of the T-shaped fire protection assembly. For example, the passageway can be part of a separate fire protection device that is coupled to the branch connector. Preferably, in some embodiments, the fire protection assembly can be a monolithic T-shaped structure in which the fitting wall and the pipe wall are formed of a homogenous material and/or the T-shaped structure is, for example, a cast assembly.

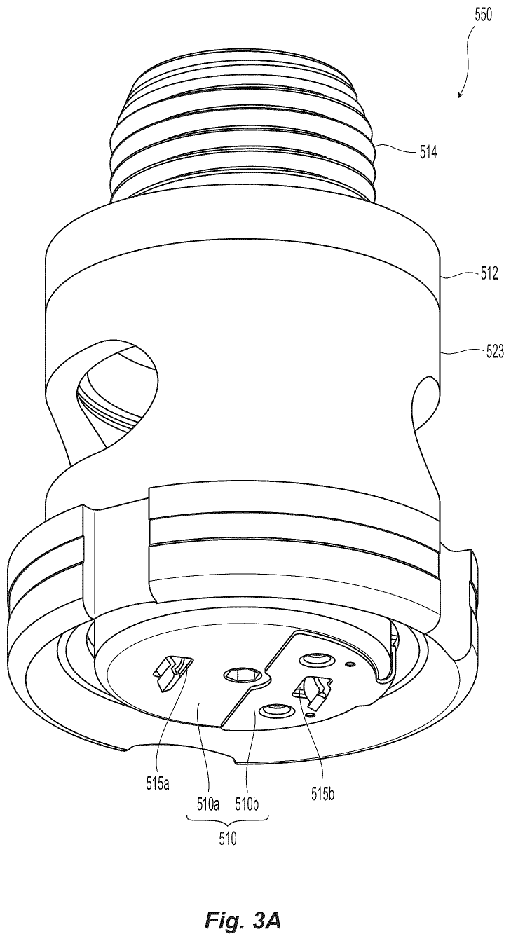

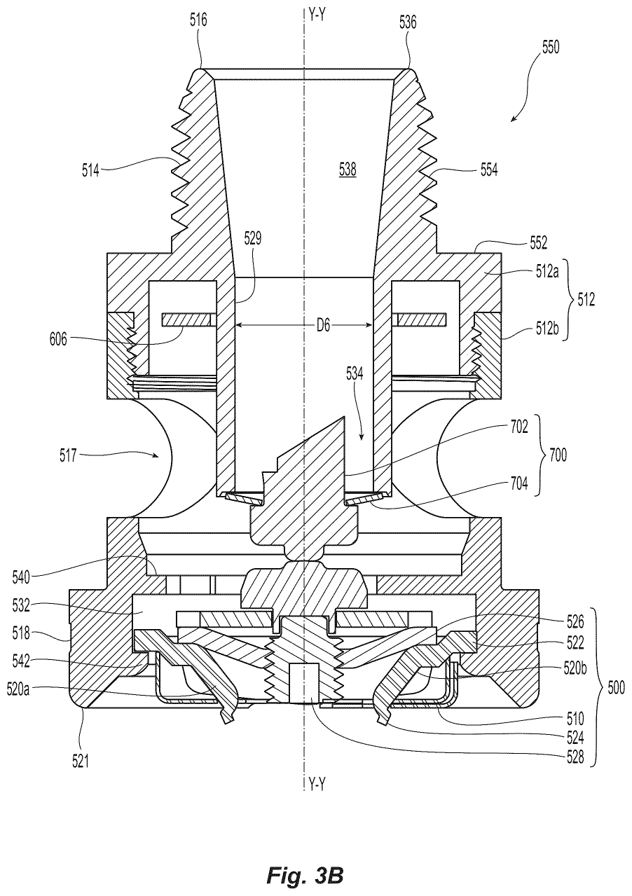

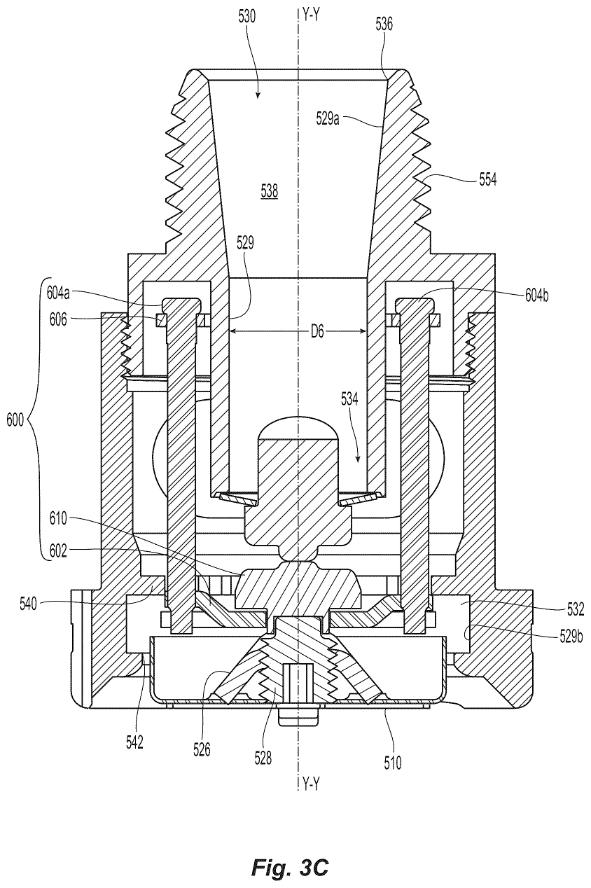

FIG. 1A illustrates a close-up perspective view of the fire protection assembly 330 of the fire protection system 100 at circle “IA”. In some embodiments, the fire protection assembly can be comprised of multiple components. In some embodiments, the components of the fire protection assembly 330 can be comprised of separate components that are coupled together. However, in other embodiments, at least some of the components of the fire protection assembly 330 can be integrated, for example, as a T-shaped structure. In some embodiments, the fire protection assembly 330 can include a fire protection device (e.g., a sprinkler, or any thermally actuated structure configured to distribute a firefighting fluid when in the presence of sufficient heat). For clarity and brevity, an embodiment of the fire protection assembly having a sprinkler is discussed, but other types of fire protection devices can be used. Preferably, the fire protection device is an automatic fire protection sprinkler 550 (see FIG. 1B and FIGS. 3A to 3C). An example of a preferred embodiment of the fire protection device is provided in U.S. Pat. No. 11,344,758, which is incorporated by reference in its entirety. However, a person of ordinary skill in the art will recognize that any thermally actuated sprinkler can be used.

In some embodiments, one or more fire protection assemblies 330 can be fluidly connected to the branch line 210, for example, via welding, threaded couplings, a tongue and groove couplings, an interference fit, a snap fit, a soldered coupling, a glued coupling, a mechanical fit, or some other type of coupling. Preferably, the fire protection assembly 330 includes a pipe wall 332 arranged around a central axis X-X that defines a supply volume 336 for receiving firefighting fluid from the branch line 210 and/or the riser pipe 200. In preferred embodiments of the system, the pipe wall 332 has a fluid passageway 338 extending along the central axis X-X of the supply volume 336. The fire protection assembly 330 can include a fitting wall 334 arranged around a central axis Y-Y that defines a fitting volume 312. In some embodiments, the fitting wall 334 can be fluidly connected to the pipe wall 332.

Preferably, the fitting volume 312 accommodates at least a portion of the sprinkler 550. In some embodiments, the entire sprinkler 550 fits in fitting volume 312 (e.g., in at least the unactuated state). In some embodiments, the pipe wall 332 can be part of a pipe header. In some embodiments, the fitting wall 334 can be part of a pipe fitting.

FIG. 1B illustrates a front cross-section view of the fire protection assembly 330, including sprinkler 550. As shown in FIG. 1B, in some embodiments, the fitting wall 334 can extend a distance D1 from an inner surface of the pipe wall 332 into the supply volume 336. Preferably, the distance D1 is equal to or less than a distance between the inner surface of the pipe wall 332 and the central axis X-X of the supply volume 336. In some embodiments, the distance D1 can be zero in that the fitting wall 334 does not extend into the supply volume 336. In some embodiments, the fitting wall 334 can be an impervious wall that is configured to shield and/or protect the sprinkler 550 from accidental damage. For example, the impervious wall can be composed of materials (e.g., metals, metal alloys, and/or other composites such as, aluminum, steel, stainless-steel, iron, and/or another appropriate material) and/or have a thickness that provide a structural strength to the fitting wall 334 that is sufficient to protect the sprinkler 550 from damage when hit. Preferably, the fitting wall 334 can define a fitting volume 312 that includes a protection chamber 314 (dotted line), which can house the entire sprinkler 550 in at least the unactuated state of the sprinkler 550. In some embodiments, at least the sprinkler components that are susceptible to damage such as, for example, an outlet orifice, a fluid deflection member, and/or a thermally responsive trigger can be housed and/or shielded in the protection chamber 314. In the embodiment of FIGS. 1A to 1C, the fitting volume 312 and the protection chamber 314 correspond to the same volume. Accordingly, in the present description, fitting volume 312 and protection chamber 314 are used interchangeably. However, in other embodiments, the protection chamber 414 can have a volume that is different than the fitting volume 412.

For example, as seen in FIG. 1B, in some embodiments, at least a portion of sprinkler 550 can be disposed within fitting volume 312. Preferably, the entire sprinkler 550 can be disposed within the protection chamber 314 of the fitting volume 312 in both the actuated state and the unactuated state. In some embodiments, one or more components of the sprinkler 550, including, for example, device outlet orifice 534, thermally responsive actuator assembly 500 (including thermally responsive trigger 510), and/or fluid deflector assembly 600 (including the fluid deflection member 602), are disposed within the protection chamber 314 (see FIGS. 3A to 3C).

In some embodiments, the dimensions of protection chamber 314 can be such that the sprinkler 550 can be disposed entirely within the protection chamber 314 so as to be shielded by the fitting wall 334. Preferably, a terminal end of the fitting wall 334 and a terminal end face 521 of an unactuated sprinkler 550 extend a same distance D2 from an outer surface of the pipe wall 332 such that sprinkler 550 (e.g., including at least the device outlet orifice 534, thermally responsive actuator assembly 500, including thermally responsive trigger 510, and/or fluid deflector assembly 600, including the fluid deflection member 602) is disposed within the protection chamber 314 when the sprinkler 550 is in the unactuated position. In other embodiments, the terminal end of the fitting wall 334 can extend beyond the terminal end face 521 of the unactuated sprinkler 550. Preferably, in such embodiments, the terminal end of the fitting wall 334 extends a distance D2 that is equal to or greater than the terminal end of an actuated sprinkler 550 (e.g., terminal end of the fluid deflection member 602 after actuation). Preferably, the distance D2 can be in a range of zero to 5 inches, more preferably in a range of 1 inch to 4 inches, and even more preferably 1.5 inches. In some embodiments, the distance D2+the outer diameter of pipe wall D3 can correspond to a width of beam 114 (which, as discussed above can act as a barrier for the fire protection assembly in a storage rack configuration) such that the terminal end of the fitting wall 334 is at a same level as or above the bottom of the beam 114. Preferably, the distance D2+D3 is in a range of 1 inch to 6 inches, and more preferably, 3 inches to 6 inches, and even more preferably 3 inches to 5 inches. Additionally, embodiments of the fitting wall 334 are formed from nominally sized pipe diameters to provide a diameter of the fitting wall that is, preferably, 1.5 inches to 2.5 inches, and, more preferably, 1.75 inches to 2.25 inches, and, for a preferred embodiment of the sprinkler 550, which has a K-factor of 25.2, the diameter of the fitting wall is 2 inches. In such embodiments, the fitting wall 334 provides protection to the sprinkler 550 that is in addition to the protection provided by the beam 114 installed on the rack assembly. However, even in cases where no protective barriers are included in a rack assembly, the fitting wall 334 can protect the sprinkler 550 from accidental damage.

In some embodiments, as seen in FIG. 1C, the fire protection assembly 330 is configured such that a distance D4 between the central axis X-X and a terminal end face 333 of the fitting wall 334 is less than or equal to the inner diameter D5 of the pipe wall 332 plus a diameter D6 of the device outlet orifice 534 of sprinkler 550 (see FIG. 3B). By configuring the fire protection assembly 330 such that D4 is less than or equal to D5+D6, the fire protection assembly 330 can have a compact design that is advantageous in in-rack systems (e.g., in-rack system 100).

As seen in FIG. 1C, the fitting wall 334 can have a generally tubular shape with a fitting inlet end 342 for fluid connection to the supply volume 336 and a fitting outlet end 344 for receiving the sprinkler 550 within the fitting volume 312. The fitting wall 334 is preferably formed as a straight fitting or alternatively can be formed as a different type of fitting, such as an elbow fitting or tee fitting to connect an appropriately configured sprinkler. For example, in FIG. 1C, the fitting wall 334 is generally formed as a straight fitting but includes a ledge 362 that interfaces to pipe wall 332 to facilitate installation. The ledge 362 can facilitate a mechanical coupling and/or mechanical fit of the fitting wall 334 to the pipe wall 332 via, for example, weld 364. The fitting wall 334 is preferably formed as a single-piece, monolithic, or unitary structure. Moreover, the fitting wall 334 is preferably formed or fabricated from a weldable material such as steel or a weldable grade iron (and/or another metal or meal alloy) for welded connection to the pipe wall 332. However, in other embodiments, the fitting wall 334 can be formed from multiple components and/or can be made from other materials. In preferred embodiments of the fitting wall 334, the fitting inlet end 342 includes a saddle-shaped portion that is circumscribed about the central branch axis Y-Y. The preferred saddle-shaped surface is configured to cradle the pipe wall 332 in a preferred welded connection. In some embodiments, the combined pipe wall 332 and the fitting wall 334 can be formed or machined as a single piece, monolithic, or unitary structure.

As shown in FIG. 1C, the fitting wall 334 can include an internal passageway 348 defined by the fitting wall 334, which can be, for example, an impervious wall, that is preferably circumscribed about a central connector axis Y-Y, and the internal passageway 348 can extend from the fitting inlet end 342 to the fitting outlet end 344. The internal passageway 348 preferably includes an internal surface 346 that extends from the fitting inlet end 342 to the fitting outlet end 344. Preferably, the profile of the internal surface 346 corresponds to the outer surface profile of the fire protection device. For example, see FIG. 1B where the profile of the internal surface 346 generally corresponds to the outer surface profile of the sprinkler 550. Preferably, the internal surface 346 of the fitting wall 334 is configured to provide a mechanical coupling to a fire protection device (e.g., sprinkler 550). Based on the type of fire protection device, the mechanical coupling can be a threaded surface that spans at least a portion of the internal surface 346. For example, as shown in FIG. 1C, the fitting internal thread 352 can be located proximate to the fitting inlet end 342 (see location A). In some embodiments, depending on the type of fire protection device, the mechanical coupling (e.g., a threaded surface) can be located proximate to the fitting outlet end 344 or anywhere between the fitting inlet end 342 and the fitting outlet end 344. For example, a threaded surface can be disposed in location B and/or location C. In some embodiments, instead of a threaded surface, the mechanical coupling can be, for example, a mechanical fit (e.g., an interference fit, snap fit, press fit, and/or interlocking mechanism). Preferably, once the sprinkler 550 is installed, the internal surface 346 does not come into contact with the firefighting fluid.

The fitting volume 312 can receive sprinkler 550 and, when mechanically coupled to the fitting wall 334, the sprinkler 550 fluidly connects to the supply volume 336. In some embodiments, to aid in installing the sprinkler 550, the internal surface 346 of the fitting wall 334 can have an annular step portion 366 that can act as a backstop for limiting the travel of the sprinkler 550 when installed. In some embodiments, the sprinkler 550 can be threaded (e.g., hand threaded and/or via a wrench) into the fitting wall 334 to form a fluid-tight engagement between the sprinkler 550 and the fitting wall 334. For example, the sprinkler 550 can include a device external thread 554, which is tapered, at the device inlet end 514. The sprinkler 550 is then threaded into the fitting internal thread 352, which is tapered, of the fitting wall 334 to form the fluid-tight sealed engagement. Preferably, when both threads 352 and 554 are tapered, a fluid-type seal can be formed between the threads.

However, in some embodiments, one or both threads 352 and 554 can be straight instead of tapered. In such embodiments, to aid in forming a fluid-tight sealed engagement between the sprinkler 550 and the fitting wall 334, an annular seal member 360 can be disposed on, for example, an inlet flange portion 552 of the sprinkler 550. When the sprinkler 550 is threaded into the fitting wall 334, the annular seal member 360 can be compressed and/or deformed between the annual step portion 366 and the inlet flange portion 552 to provide a leak-proof fluid-tight seal between the sprinkler 550 and the fitting wall 334 and to fluidly isolate the supply volume 336 from the external environment. The annular seal member 360 allows for a lower torque as opposed to the higher torque that would be required in a typical fire protection sprinkler installation using a wrench and cooperating tapered threads.

In some embodiments, a straight internal thread 352 with the annular seal member 360 permits a straight threaded sprinkler 550 (e.g., each with threads having a fine pitch) to be rotatable about the axis Y-Y within the fitting wall 334 such that the sprinkler 550 can be rotationally oriented, preferably by hand, in any desired position while forming a proper fluid-tight seal. Preferably, the sprinkler 550 is rotationally oriented such that a frame arm of the sprinkler 550 is aligned along the central axis X-X of the pipe wall 332. More preferably, the fitting internal thread 352 and/or the annular seal member 360 form a proper fluid-tight seal engagement with the sprinkler 550 upon sufficient rotation of the device by hand following contact with device external thread 554 and/or the annular seal member 360. However, in some embodiments, the fire protection assembly 330 with straight threads may not include the annular seal member 360.

In FIG. 1B, the fitting internal thread 352 of the fitting wall 334 is disposed in location A (see FIG. 1C) with the annular seal member 360 disposed downstream of the fitting internal thread 352 in a flow direction. However, in other embodiments, the annular seal member 360 can be disposed upstream of the fitting internal thread. For example, in some embodiments, the fitting internal thread and the corresponding device external thread of the sprinkler 550 can be disposed in location B and/or in location C (see FIG. 1C). In such embodiments, the annular seal member 360 can be disposed upstream of the threaded engagement on inlet flange portion 552 of the sprinkler 550. In some embodiments, the annular seal member 360 can be, for example, a gasket and/or an O-ring made of a compressible material (e.g., rubber or other applicable material).

FIGS. 2A and 2B illustrate a perspective view and a side cross-sectional view, respectively, of a fire protection assembly in accordance with an embodiment of the present disclosure. The fire protection assembly 430 of FIGS. 2A and 2B can be, for example, similar in function to the fire protection assembly 330. However, in the present embodiments, the fitting wall can be an angled structure (e.g., an angled pipe) instead of a straight fitting like fitting wall 334. In some embodiments, the components of the fire protection assembly 430 can be comprised of separate components that are coupled together. For example, the angled fitting wall 434 can be composed of two or more components that are coupled (e.g., via welding, threaded couplings, a tongue and groove couplings, mechanical fit (e.g., an interference fit, a snap fit, a press fit) a soldered coupling, a glued coupling, or some other type of coupling). In other embodiments, at least some of the components of the fire protection assembly 430 can be integrated. For example, the angled fitting wall 434 can be of a single piece construction and/or the angled fitting wall 434 and the pipe wall 432 can be an integrated one-piece structure.

In some embodiments, the fire protection assembly 430 can include a thermally actuated fire protection device (e.g., a sprinkler, or any thermally actuated structure configured to distribute a firefighting fluid when in the presence of sufficient heat). For clarity and brevity, an embodiment of the fire protection assembly having a sprinkler is discussed. Preferably, the fire protection device is an automatic sprinkler 550 (see FIGS. 3A to 3C).

In some embodiments, one or more fire protection assemblies 430 can be fluidly connected to the branch line 210, for example, via welding, threaded couplings, a tongue and groove couplings, mechanical fit, a soldered coupling, a glued coupling, or some other type of coupling. Preferably, the fire protection assembly 430 includes a pipe wall 432 arranged around a central axis X-X that defines a supply volume 436 for receiving firefighting fluid from the branch line 210 and/or the riser pipe 200. In some embodiments, the pipe wall 432 can be part of a pipe header. In preferred embodiments of the system, the pipe wall 432 has a fluid passageway 438 extending along the central axis X-X of the supply volume 436. The fire protection assembly 430 can include a fitting structure having an angled fitting wall 434. In some embodiments, the angled fitting wall 434 can be part of a pipe fitting. The angled fitting wall 434 can be fluidly connected to the pipe wall 432 and can direct the firefighting fluid flow along a flow path F. Preferably, the angled fitting wall 434 includes a pipe coupling portion 434a that defines a fitting-supply volume 441 and a device coupling portion 434b that defines a fitting volume 412. In some embodiments, the pipe coupling portion 434a can be disposed transverse to and coupled (e.g., directly coupled) to the pipe wall 432. Preferably, the device coupling portion 434b is disposed adjacent to and coupled (e.g., directly coupled) to the pipe coupling portion 434a and spaced apart from the pipe wall 432. Preferably, a central axis A-A of the pipe coupling portion 434a forms an angle relative to a central axis B-B of the device coupling portion 434b. As used herein, “an angle” between two axes means that the axes are not colinear or parallel with each other. In some embodiments, the central axis A-A of the pipe coupling portion 434a and the central axis B-B of the device coupling portion 434b form an angle α that is in a range of 30 degrees to less than 180 degrees, and preferably in a range of 45 degrees to less than 180 degrees. In some embodiments, the angle α can be about 90 degrees (e.g., within ±1 degree depending on manufacturing tolerances), which can create an angled connection as seen FIG. 2A. Preferably, the device coupling portion 434b is positioned to accommodate a pendent sprinkler (e.g., central axis B-B is perpendicular to the floor or ceiling) and, based on the angle α, the coupling between the pipe coupling portion 434a and the pipe wall 432 is appropriately located. For example, if the angle α equals 90 degrees, the central axis A-A of the pipe coupling portion is disposed parallel to a horizontal plane (e.g., the floor of the protected space). If the angle α is less than 90 degrees, the central axis A-A of the pipe coupling portion 434a is angled above the horizontal plane, and if the angle α is greater than 90 degrees, the central axis A-A is angled below the horizontal plane.

FIG. 2B illustrates a side cross-section view of the fire protection assembly 430, including sprinkler 550. As shown in FIG. 2B, in some embodiments, the device coupling portion 434b of the angled fitting wall 434 can include a step portion that extends a distance D7 from an inner surface of the pipe coupling portion 434a of angled fitting wall 434 into the fitting-supply volume 441 of the pipe coupling portion 434a. Preferably, the distance D7 is equal to or less than a distance between the inner surface of the pipe coupling portion 434a and the central axis A-A of the fitting-supply volume 441. In some embodiments, the distance D7 can be zero (e.g., the device coupling portion 434b may not include the step portion). In some embodiments, when D7 is zero, the sprinkler 550 still extends into the fitting-supply volume 441.

In some embodiments, the angled fitting wall 434 can be an impervious wall that is configured to shield and/or protect the sprinkler 550 from accidental damage. For example, the impervious wall can be composed of materials (e.g., metals, metal alloys, and/or other composites such as, aluminum, steel, stainless-steel, iron, and/or another appropriate material) and/or have a thickness that provide a structural strength to the angled fitting wall 434, including device coupling portion 434b, that is sufficient to protect the sprinkler 550 from damage when hit. In some embodiments, at least device coupling portion 434b is an impervious wall and more preferably, the entire angled fitting wall 434 is an impervious wall. Preferably, the fitting volume 412 accommodates at least a portion of the sprinkler 550. For example, the fitting volume 412 includes a protection chamber 414 (dotted line) that can house the entire sprinkler 550 in at least the unactuated state of the sprinkler 550. In some embodiments, at least the sprinkler components that are susceptible to damage such as, for example, an outlet orifice, a fluid deflection member, and/or a thermally responsive trigger can be housed and/or shielded in the protection chamber 414. In the embodiment of FIGS. 2A and 2B, the fitting volume 412 and the protection chamber 414 correspond to the same volume. Accordingly, in the present description, fitting volume 412 and protection chamber 414 are used interchangeably. However, in other embodiments, the protection chamber 414 can have a volume that is different than the fitting volume 412.

Preferably, the entire sprinkler 550 can be disposed within the protection chamber 414 of the fitting volume 412 in both the actuated state and the unactuated state. In some embodiments, one or more components of the sprinkler 550, including, for example, device outlet orifice 534, thermally responsive actuator assembly 500 (including thermally responsive trigger 510), and/or fluid deflector assembly 600 (including the fluid deflection member 602), are disposed within the protection chamber 414 (see FIGS. 3A to 3C).

In some embodiments, the dimensions of protection chamber 414 can be such that the sprinkler 550 can be disposed entirely within the protection chamber 414 so as to be shielded by at least device coupling portion 434b of angled fitting wall 434. Preferably, a terminal end 433 of the angled fitting wall 434 and a terminal end face 521 of an unactuated sprinkler 550 extend a same distance D8 from an outer surface of the pipe wall 432 such that sprinkler 550 (e.g., including at least the device outlet orifice 534, thermally responsive actuator assembly 500, including thermally responsive trigger 510, and/or fluid deflector assembly 600, including the fluid deflection member 602) is disposed within the protection chamber 414 when the sprinkler 550 is in the unactuated position. In other embodiments, the terminal end 433 of the angled fitting wall 434 can extend beyond the terminal end face 521 of the unactuated sprinkler 550. Preferably, in such embodiments, the terminal end 433 of the angled fitting wall 434 extends a distance D8 that is equal to or greater than the terminal end of an actuated sprinkler 550 (e.g., terminal end of the fluid deflection member 602 after actuation). Preferably, the distance D8 can be in a range of zero to 5 inches, more preferably in a range of 1 inch to 4 inches, and even more preferably about 1.5 inches ±0.1 inch. In some embodiments, the distance D8 plus the outer diameter of pipe wall D3 can correspond to a width of beam 114 (which, as discussed above can act as a barrier for the fire protection assembly in an in-rack system) such that the terminal end of the angled fitting wall 434 is at a same level as or above the bottom of the beam 114. In some embodiments, the bottom of the pipe wall 432 extends to the terminal end 433 of the angled fitting wall 434 (e.g., the distance D8 is zero). For example, the distance D4 from the central axis X-X to the terminal end 433 of the angled fitting wall 434 equals the outer radius (0.5*D3) of the pipe wall 432. In other embodiments, the bottom of the pipe wall 432 extends beyond the terminal end 433 of the angled fitting wall 434. For example, the distance D4 is less than the outer radius (0.5*D3) of the pipe wall 432. Based on the angle α and/or the arrangement between the pipe coupling portion 434a, device coupling portion 434b, and/or the pipe wall 432, the bottom of pipe wall 432 can extend to or beyond the terminal end 433 of the angled fitting wall 434 or the terminal end 433 can extend beyond the bottom of the pipe wall 432. When the bottom of pipe wall 432 extend to or beyond the terminal end 433, the pipe wall 432 can provide additional shielding to protect the fire protection device. In such embodiments, the pipe wall 432 provides protection to the sprinkler 550 that is in addition to the protection provided by the beam 114 and/or the device coupling portion 434b. However, even in cases where no protective barriers are included in a rack assembly and/or the pipe wall 432 does not cover the sprinkler 550, the angled fitting wall 434 can protect the sprinkler 550 from accidental damage. Preferably, the distance D8+D3 is in a range of 1 inch to 6 inches, and more preferably, 3 inches to 6 inches, and even more preferably 3 inches to 5 inches.

In some embodiments, the fire protection assembly 430 is configured such that a distance D10 between the central axis A-A of the pipe coupling portion 434a and a terminal end 433 of the second coupling portion 434b less than or equal to the inner diameter D9 of the pipe coupling portion 434a of the fitting wall 434 plus a diameter D6 of the device outlet orifice 534 of sprinkler 550. By configuring the fire protection assembly 430 such that D10 is less than or equal to D9+D6, the fire protection assembly 430 can have a compact design that is advantageous in in-rack systems (e.g., in-rack system 100 of FIG. 1).

As seen in FIGS. 2A and 2B, the angled fitting wall 434, which includes pipe coupling portion 434a and the device coupling portion 434b, can have a fitting inlet end 443 for fluid connection to the supply volume 436 and a fitting outlet end 444 for receiving the sprinkler 550 within the fitting volume 412. Preferably, the pipe coupling portion 434a and the device coupling portion 434b can be mechanically coupled using weld 465. However, other types of mechanical couplings can be used such as, for example, a threaded coupling, a mechanical fit, a soldered coupling, a glued coupling, and/or another type of mechanical coupling. In some embodiments, one or more components of the angled fitting wall 434 can include features for facilitating the mechanical coupling. For example, as shown in FIG. 2B, the device coupling portion 434b of the angled fitting wall 434 can include a ledge 462 that interfaces to the pipe coupling portion 434a of angled fitting wall 434 to facilitate installation.

In some embodiments, the angled fitting wall 434 can be formed as a single-piece, monolithic, or unitary structure. Moreover, the angled fitting wall 434 is preferably formed or fabricated from a weldable material such as steel or a weldable grade iron (and/or another metal or meal alloy) for welded connection to the pipe wall 432. However, in other embodiments, the angled fitting wall 434 can be formed from two or more components and/or can be made from other materials. In preferred embodiments of the angled fitting wall 434, the fitting inlet end 443 includes a saddle-shaped portion that is circumscribed about the central axis A-A. The preferred saddle-shaped surface is configured to cradle the pipe wall 432 in a preferred welded connection 464. In some embodiments, the combined pipe wall 432 and the angled fitting wall 434 can be formed or machined as a single piece, monolithic, or unitary structure.

As shown in FIG. 2B, the fitting wall 434 can include a flow path F that extends from the fitting inlet end 443 to the fitting outlet end 444. Preferably, the device coupling portion 434b of the flow path F includes an internal surface 446 that extends from the device coupling inlet end 442 to the fitting outlet end 444. Preferably, the profile of the internal surface 446 corresponds to the outer surface profile of the fire protection device. For example, as seen FIG. 2B, the profile of the internal surface 446 generally corresponds to the outer surface profile of the sprinkler 550 (similar to that shown in FIGS. 1B and 1C). Preferably, the internal surface 446 of the angled fitting wall 434 is configured to provide a mechanical coupling to a fire protection device (e.g., sprinkler 550). Based on the type of fire protection device, the mechanical coupling can be a threaded surface that spans at least a portion of the internal surface 446. For example, the fitting internal thread 452 can be located proximate to the device coupling inlet end 443 (see location A). In some embodiments, depending on the type of fire protection device, the mechanical coupling (e.g., threaded surface) can be located proximate to the fitting outlet end 444 or anywhere between the device coupling inlet end 443 and the fitting outlet end 444. For example, the mechanical coupling (e.g., a threaded surface) can be disposed in location B and/or location C. In some embodiments, instead of a threaded surface, the mechanical coupling can be, for example, a mechanical fit. Preferably, once the sprinkler 550 is installed, the internal surface 446 does not come into contact with the firefighting fluid.

The fitting volume 412 can receive sprinkler 550 and, when the sprinkler 550 is mechanically coupled to the angled fitting wall 434, the sprinkler 550 fluidly connects to the supply volume 436 via fitting-supply volume 441. In some embodiments, to aid in installing the sprinkler 550, the internal surface 446 of device coupling portion 434b can have an annular step portion 466 that can act as a backstop for limiting the travel of the sprinkler 550 when installed. In some embodiments, the sprinkler 550 can be threaded (e.g., hand threaded and/or via a wrench) into the angled fitting wall 434 to form a fluid-tight engagement between the sprinkler 550 and the angled fitting wall 434. For example, the sprinkler 550 can include a device external thread 554, which is tapered, at the device inlet end 514. The sprinkler 550 is then threaded into the fitting internal thread 452, which is tapered, of the fitting wall 334 to form the fluid-tight sealed engagement. Preferably, when both threads 452 and 554 are tapered, a fluid-type seal can be formed between the threads.

However, in some embodiments, one or both threads 452 and 554 can be straight instead of tapered. In such embodiments, to aid in forming a fluid-tight sealed engagement between the sprinkler 550 and the angled fitting wall 434, an annular seal member 460 can be disposed on, for example, an inlet flange portion 552 of the sprinkler 550 (see FIG. 3B). When the sprinkler 550 is threaded into the angled fitting wall 434, the annular seal member 460 can be compressed and/or deformed between the annual step portion 466 and the inlet flange portion 552 to provide a leak-proof fluid-tight seal between the sprinkler 550 and the angled fitting wall 434 and to fluidly isolate the fitting-supply volume 441 from the external environment. The annular seal member 460 allows for a lower torque as opposed to the higher torque that would be required in a typical fire protection device installation using a wrench and cooperating tapered threads.

In some embodiments, a fitting internal thread 452 that is straight with the annular seal member 460 permits a straight threaded sprinkler 550 (e.g., each with threads having a fine pitch) to be rotatable about the axis Y-Y within the device coupling portion 434b such that the sprinkler 550 can be rotationally oriented, preferably by hand, in any desired position while forming a proper fluid-tight seal. Preferably, the sprinkler 550 is rotationally oriented such that a frame arm of the sprinkler 550 is aligned along the central axis X-X of the pipe wall 432. More preferably, the fitting internal thread 452 and/or the annular seal member 460 form a proper fluid-tight seal engagement with the sprinkler 550 upon sufficient rotation of the device by hand following contact with device external thread 554 and/or the annular seal member 460. However, in some embodiments, the fire protection assembly 430 with straight threads may not include the annular seal member 460.

In FIG. 2B, the fitting internal thread 452 of the fitting wall 434 is disposed in location A with the annular seal member 460 disposed downstream of the fitting internal thread 452 in a flow direction. However, in other embodiments, the annular seal member 460 can be disposed upstream of the fitting internal thread. For example, in some embodiments, the fitting internal thread and the corresponding device external thread of the sprinkler 550 can be disposed in location B and/or in location C. In such embodiments, the annular seal member 460 can be disposed upstream of the threaded engagement on inlet flange portion 552 of the sprinkler 550. In some embodiments, the annular seal member 460 can be, for example, a gasket and/or an O-ring made of a compressible material (e.g., rubber or other applicable material).

FIG. 3A illustrates a perspective view and FIGS. 3B and 3C illustrate cross-sectional views of a sprinkler consistent with embodiments of the present disclosure. As discussed above, the fire protection assembly 330 can include an automatic sprinkler 550 as the fire protection device that is shielded by the fitting wall 334. With reference to FIGS. 3A to 3C, the preferred sprinkler 550 includes an elongate device housing 512 extending along a sprinkler axis Y-Y having a device inlet end 514 with an inlet end face 516 and a device outlet end 518 having a terminal end face 521. The device inlet end 514 and the device outlet end 518 are axially spaced apart from one another along the sprinkler axis Y-Y to define the axial length of the device housing 512. The device housing 512 has a device outer surface 523 defining an external profile of the device housing that facilitates sprinkler 550 assembly and installation. As discussed above, the device outer surface 523 at device inlet end 514 is configured for coupling the sprinkler 550 to the fitting wall 334. For example, the device outer surface 523 proximate to the inlet end face 516 preferably includes a device external thread 554 for coupling to, for example, fitting internal thread 352 of the fitting wall 334. In some embodiments, the device outer surface 523 at the device inlet end 514 can be alternatively configured to provide for a different mechanical coupling, for example, a groove connection, a snap fit connection, or an interference fit connection.

Preferably, the device housing 512 includes an internal surface 529 extending from the inlet end face 516 to the terminal end face 521 to define an internal conduit 530 of the device housing 512 for housing various operating components of the sprinkler 550 and defining a flow passageway 538 therethrough. As described herein, the sprinkler 550 includes a thermally responsive actuator assembly 500 having a preferred thermally responsive trigger 510 disposed at the terminal end face 521 proximate the internal conduit 530 and more preferably inserted into the internal conduit 530 of the device housing 512 at the device outlet end 518. The preferred thermally responsive trigger 510 can shield or obscure the internal conduit 530 thereby protecting components disposed therein. That is, the device housing 512 and thermally responsive trigger 510 define a preferred relationship in order to reduce sites along the sprinkler assembly that may be accidentally or intentionally impacted or tampered with. Additionally, preferred embodiments of the thermally responsive trigger 510 convey information about the sprinkler 550, such as for example, manufacturing identifying information, sprinkler installation information and/or sprinkler performance information. In preferred embodiments, the thermally responsive trigger 510 includes visible markings or indicia to convey the desired information.

The sprinkler 550 can include a fluid deflector assembly 600 or portion thereof that translates preferably from a position within an internal device chamber 532 of the internal conduit 530 in an unactuated state of the sprinkler 550 to a position external the internal device chamber 532 and the device housing 512 in an actuated state of the sprinkler 550. In the unactuated state of the sprinkler 550, the thermally responsive actuator assembly 500 supports the fluid deflector assembly 600 within the internal device chamber 532. The fluid deflector assembly 600 can maintain or support the seal assembly 700 within a device outlet orifice 534 of the device housing 512. Preferably, the device outlet orifice 534 is formed along the internal surface 529 and centered along the sprinkler axis Y-Y of the internal conduit 530 between the inlet end face 516 and terminal end face 521. The internal surface 529 can define a device inlet orifice 536 proximate the inlet end face 516 and a flow passageway 538 that extends from the device inlet orifice 536 to the device outlet orifice 534. When the sprinkler 550 is coupled to the fitting wall 334, the device inlet orifice 536 can be fluid communication with supply volume 336. In some embodiments, the device inlet orifice 536 can be disposed within the supply volume 336. In exemplary embodiments of the present disclosure, the device outlet orifice 534 and/or fluid deflector assembly 600, including the fluid deflection member 602 can be disposed within the protection chamber 314 when the sprinkler 550 is in the unactuated state. In some embodiments, the fluid deflection member 602 can be disposed outside the protection chamber 314 when the sprinkler 550 is in the actuated state.

Formed at an axial distance from the device outlet orifice 534 and between the device outlet orifice 534 and the terminal end face 521 is the internal device chamber 532. The internal surface 529 includes a first annular flange 540 and a second annular flange 542, each circumscribing the sprinkler axis Y-Y and coaxially spaced apart from one another to form the internal device chamber 532 in between one another.

The housing 512 can be formed as a single integrated component or alternatively be formed from multiple components. In the preferred embodiment shown in FIGS. 3A to 3C, the housing 512 includes a first component 512a and a second component 512b coupled to one another by a preferred threaded engagement. The first component 512a is a preferred body forming the device inlet end 514 having a first internal surface 529a defining the device inlet orifice 536 and the device outlet orifice 534 with the fluid flow passageway 538 extending between the device inlet orifice 536 and the device outlet orifice 534. The second component 512b of the device housing 512 forms the device outlet end 518 and includes a second internal surface 529b that defines the internal device chamber 532 axially spaced from the device outlet orifice 534 for housing the fluid deflector assembly 600 or portions thereof such as, for example, the fluid deflection member 602. To facilitate flow of heat through the sprinkler 550 and thermal exposure of the thermally responsive actuator assembly 500 to maximize thermal responsiveness, the second component 512b preferably includes one or more openings 517 providing heat flow access to the internal conduit 530.

The fluid flow passageway 538 extending between the device inlet orifice 536 and the device outlet orifice 534 defines a nominal K-factor of the sprinkler 550. As discussed above, the nominal K-factor of a fire protection device is defined as K=Q/P^{1/2}, where Q represents the flow rate (gallons/min (gpm) of firefighting fluid from an outlet of an internal passage through a body of the sprinkler and P represents the pressure (pounds per square inch (psi)) of firefighting fluid fed into an inlet end of the internal passageway through the body of the sprinkler. In some embodiments, the nominal K-factor can be 2.8[gpm/(psi)^{1/2}] or greater, preferably a nominal K-factor in a range of 11.2 to 33.6[gpm/(psi)^{1/2}], and more preferably a nominal K-factor that is any one of 11.2, 14.0, 16.8, 19.6, 22.4, 25.2, 28.0, 30.8, or 33.6[gpm/(psi)^{1/2}].

To control the thermal operation of the sprinkler 550, the thermally responsive actuator assembly 500 forms a surface contact engagement with the internal surface 529 of the device housing 512 to provide the support to the fluid deflector assembly 600 and the seal assembly 700 in their respective unactuated positions within the device housing 512. The thermally responsive actuator assembly 500 includes a first lever member 520a and a second lever member 520b each having a first end 522 and a second end 524. In the unactuated state of the sprinkler, the first ends 522 of the lever members 520a, 520b are in surface contact with the second annular flange 542 and diametrically opposed from one another about the internal conduit 530. The second ends 524 of the lever members 520a, 520b are engaged with the thermally responsive trigger 510 to support and preferably locate the thermally responsive trigger 510 within the internal conduit 530 of the housing 512 as previously described. The first and second lever members 520a, 520b engage different soldered elements of the thermally responsive trigger 510 at the thermal detection end 514. The soldered thermally responsive trigger 510 preferably includes a bottom element 510a and a top element 510b that are soldered together at the thermal detection end 514 to form the pair of apertures 515a, 515b for engagement by the respective second ends 524 of the lever members 520a, 520b. In exemplary embodiments of the present disclosure, the thermally responsive actuator assembly 500, including thermally responsive trigger 510, can be disposed within the protection chamber 314. For example, the thermally responsive trigger 510 can be disposed within the protection chamber 314 when the sprinkler 550 is in the unactuated state.

Preferably, the thermally responsive actuator assembly 500 further includes a lever bar member 526 supported across the first and second lever members 520a, 520b and a load screw 528 in threaded engagement with the lever bar member 526 to generate a sealing force against the fluid deflector assembly 600 and preferably support the fluid deflector assembly 600, including the fluid deflection member 602, or portions thereof within the internal device chamber 532 of the device housing 512. The fluid deflector assembly 600 transfers the sealing force to the seal assembly 700 to provide a sealed engagement within the device outlet orifice 534. The seal assembly 700 preferably includes a closure device 702 having a spring plate 704 disposed about a seat of the closure device. Under the sealing force of the load screw applied through the fluid deflector assembly 600, the spring plate 704 forms a fluid tight seal against a seating surface formed at the device outlet orifice 534. The spring plate 704 preferably biases the seal assembly 700 away from the orifice to facilitate ejection of the closure device 702 out the sprinkler housing upon thermal actuation.

As previously described, the solder of the thermally responsive trigger 510 fuses in the presence of a sufficient level of heat. Upon proper solder fusion, the thermally responsive trigger 510 collapses and the elements 510a, 510b separate from one another to take the lever members out of surface contact engagement with the second annular flange 542 of the device housing 512. Without the support of the thermally responsive actuator assembly 500 in place, the fluid deflector assembly 600 translates out of the internal device chamber 532 and the seal assembly 700 ejects free from the device outlet orifice 534 under the force of the firefighting fluid which discharges out of the device outlet orifice 534 to impact the fluid deflector assembly 600 and address the fire or thermal event below the sprinkler. For example, the fluid deflector assembly 600 can include a fluid deflection member 602 that is fabricated and formed to distribute and deflect firefighting fluid in a manner to effectively address a fire and/or wet a surrounding area.

The fluid deflector assembly 600 includes a pair of pin members 604a, 604b diametrically opposed from one another about the device outlet orifice 534 and affixed to the fluid deflection member 602 for axial translation of the fluid deflection member 602. The pin members 604a, 604b are in a preferred sliding engagement with the housing 512 to preferably locate the fluid deflection member 602 within the internal device chamber 532 in the unactuated state of the sprinkler 550 and locate the fluid deflection member 602 outside of the housing 512 in the actuated state of the sprinkler 550. More preferably, the pin members 604a, 604b are in a preferred sliding engagement with the first annular flange 540 to locate the fluid deflection member 602 in each of the unactuated and actuated states of the sprinkler 550. To support and align the pin members 604a, 604b the fluid deflector assembly 600 can include an alignment ring 606 disposed within the housing 512 and which preferably circumscribes and slides about the flow passageway 538. A projection button 610 is preferably centrally secured to an upstream side of the fluid deflection member 602. The projection button 610 includes an impact end that confronts the device outlet orifice 534 and an opposite end that is configured to engage a preferred central hole formed in the fluid deflection member 602. The projection button 610 includes a generally cylindrical sidewall that is centered about the sprinkler axis Y-Y.

In some embodiments, the fluid deflector assembly 600, including the fluid deflection member 602, is within the protection chamber 314 in both the actuated state and unactuated state of the sprinkler 550. In other embodiments, the fluid deflector assembly 600 is within the protection chamber 314 in the actuated state, and at least a portion of the fluid deflector assembly 600 can be external to the protection chamber 314 in the unactuated state of the sprinkler 550 (for example, the fluid deflection member 602 can be external to the protection chamber 314 in the actuated state).

Although the previously described preferred embodiments of fire protection assemblies are directed to shielded sprinklers, one of ordinary skill in the art would understand that other types of thermally actuated fire protection devices can be modified to dispose some or all components of the thermally actuated fire protection device in a protection chamber defined by a fitting wall, such that the components are shielded by the fitting wall. While the present invention has been disclosed with reference to certain embodiments, numerous modifications, alterations, and changes to the described embodiments are possible without departing from the sphere and scope of the present invention, as defined in the appended claims. Accordingly, it is intended that the present invention not be limited to the described embodiments, but that it has the full scope defined by the language of the following claims, and equivalents thereof.

1.-19. (canceled)

20. A fire protection assembly comprising:
a pipe assembly including:
a pipe wall defining a pipe volume disposed along a central pipe axis, and
a fitting wall transverse to the pipe wall, the fitting wall having a first end secured to the pipe wall and a second end spaced from the first end along a fitting axis to define a fitting volume, the fitting wall further including an internal thread along the fitting axis; and
a sprinkler disposed within the fitting volume, the sprinkler comprising a housing including:
a first sprinkler portion defining a passageway, the passageway having an inlet orifice in fluid communication with the pipe volume and an outlet orifice within the fitting volume, wherein the passageway defines a nominal K-factor of the sprinkler;
a second sprinkler portion that contains a fluid deflection member and a thermally responsive trigger, the second portion disposed within the fitting volume; and
a coupling portion having an external thread that circumscribes the housing for engaging with the internal thread of the fitting wall.

21. The fire protection assembly of claim 20, wherein the internal thread is proximate the first end.

22. The fire protection assembly of claim 20, wherein the internal thread is proximate the second end.

23. The fire protection assembly of claim 20, wherein the internal thread is between the first end and the second end.

24. The fire protection assembly of claim 20, wherein the fitting wall extends into the pipe volume a distance D1, where D1 is equal to or less than a distance between an inner surface of the pipe wall and the central pipe axis.

25. The fire protection assembly of claim 24, wherein the distance D1 is zero.

26. The fire protection assembly of claim 20, wherein the inlet orifice is disposed within the pipe volume.

27. The fire protection assembly of claim 20, wherein a terminal end of the fitting wall and a terminal end face of the sprinkler extend a same distance D2 from an outer surface of the pipe wall.

28. The fire protection assembly of claim 27, wherein D2 is zero.

29. The fire protection assembly of claim 20, wherein the fluid deflection member is disposed within the fitting volume when the sprinkler is in an unactuated state and outside the fitting volume when the sprinkler is in an actuated state.

30. The fire protection assembly of claim 20, wherein the nominal K-factor is in a range of 22.4 to 33.6.

31. The fire protection assembly of claim 20, wherein the fitting wall comprises a first coupling portion and a second coupling portion, the first and second coupling portions disposed such that a first central axis of the first coupling portion is at an angle relative to a second central axis of the second coupling portion, the second coupling portion having a first end secured to the first coupling portion and a second end spaced from the first end along the second central axis to define the fitting volume, the second coupling portion further including the internal thread along the second central axis, and wherein the inlet orifice of the passageway is in fluid communication with a supply volume defined by the first coupling portion.

32. The fire protection assembly of claim 31, wherein the angle is in a range of 45 degrees to 135 degrees.

33. The fire protection assembly of claim 32, wherein the angle is 90 degrees.

34. The fire protection assembly of claim 31, wherein the internal thread is proximate the first end.

35. The fire protection assembly of claim 31, wherein the internal thread is proximate the second end.

36. The fire protection assembly of claim 31, wherein the internal thread is between the first end and the second end.

37. The fire protection assembly of claim 31, wherein the second coupling portion extends into the supply volume a distance D7, where D7 is equal to or less than a distance between an inner surface of the first coupling portion and the first central axis.

38. The fire protection assembly of claim 37, wherein the distance D7 is zero.

39. The fire protection assembly of claim 31, wherein the inlet orifice is disposed within the supply volume.

40. The fire protection assembly of claim 31, wherein a terminal end of the second coupling portion and a terminal end face of the sprinkler extend a same distance D8 from an outer surface of the pipe wall.

41. The fire protection assembly of claim 40, wherein D8 is zero.

42. The fire protection assembly of claim 31, wherein the fluid deflection member is disposed within the fitting volume when the sprinkler is in an unactuated state and outside the fitting volume when the sprinkler is in an actuated state.

43. The fire protection assembly of claim 31, wherein the nominal K-factor is in a range of 11.2 to 33.6.

44.-106. (canceled)
